(19) United States
(12) Patent Application Publication
(10) Pub. No.: US 2026/0275166 A1
(43) Pub. Date: Sep. 17, 2026

(54) A METHOD FOR WATERPROOFING SUBSTRATES

(71) Applicant: SIKA TECHNOLOGY AG, Baar (CH)

(72) Inventors: Flaviane ALVES DOS SANTOS, Lyndhurst, NJ (US); Johannes PECHER, CastelD'Azzano (IT)

(73) Assignee: SIKA TECHNOLOGY AG, Baar (CH)

(21) Appl. No.: 19/480,266

(22) PCT Filed: Jul. 25, 2024
(86) PCT No.: PCT/EP2024/071210

§ 371 Date: Oct. 30, 2025

(30) Foreign Application Priority Data
Jul. 27, 2023 (EP) 23188164.0

(51) Int. Cl. C09J 5/06; C08J 5/12; C08J 7/04; C08L 95/00; C09D 195/00; C09J 195/00

(52) U.S. Cl. CPC C09J 5/06; C08J 5/128; C08J 7/0427; C08L 95/00; C09D 195/00; C09J 195/00; C08J 2395/00; C08J 2453/02; C08J 2495/00; C09J 2203/346; C09J 2495/00

(57) ABSTRACT

A method for waterproofing a substrate including steps of: I) heating a hot melt bitumen membrane composition to provide a molten bitumen composition, II) applying a layer of the molten bitumen composition to a surface of the substrate to form a first bitumen layer, III) covering at least a portion of an upper surface of the first bitumen layer with a prefabricated reinforcement membrane, and IV) applying a layer of the molten bitumen composition to an upper surface of the prefabricated reinforcement membrane to form a second bitumen layer, wherein the prefabricated reinforcement membrane includes a polymer-modified bitumen layer including: a) bitumen B1 and b) at least one first modifying polymer MP1.

### TECHNICAL FIELD

The invention relates to waterproofing of below or above ground building constructions against penetration of water. Particularly, the invention relates use of hot-melt bitumen membrane compositions for waterproofing of roof substrates comprising a transition area.

### BACKGROUND OF THE INVENTION

In the field of construction polymeric sheets, which are often referred to as membranes, panels, sheets, or liners, are used to protect underground and above ground constructions, such as base slabs, walls, floors, basements, tunnels, wet rooms, building facades, flat and low-sloped roofs, landfills, water-retaining structures, ponds, and dikes against penetration of water, moisture, harmful gases, and volatile organic compounds. Waterproofing membranes are applied, for example, to prevent ingress of water through cracks that develop in the concrete structure due to building settlement, load deflection or concrete shrinkage. Roofing membranes are used for sealing of flat and low-sloped roof structures to prevent leaks and to move take water off the roof. Vapor barrier and retarder membranes are used to control the movement of water through a building structure by vapor diffusion whereas façade tapes are used for sealing of construction gaps in building facades, for example to seal gaps between a building structure and window or curtain wall components.

Waterproofing and roofing membranes can be provided as prefabricated articles or as in situ liquid applied membranes. The prefabricated membranes can be adhered to a surface of the substrate, for example, by using adhesives or mechanical fastening means, such as screws and/or barbed plates. Typically used materials for prefabricated membranes include thermoplastics, such as plasticized polyvinylchloride (p-PVC) and thermoplastic olefins (TPE-O, TPO), bitumen, and crosslinked elastomers, such as ethylene-propylene diene monomer (EPDM) rubber. Bitumen compositions are typically modified with synthetic polymers to improve flexibility at low temperatures, resistance to UV-radiation, and toughness.

Liquid applied membranes (LAM) are monolithic, fully bonded, liquid-based coatings that after curing form a rubber-like elastomeric seamless membrane on the surface of the substrate to be waterproofed. LAMs are commonly used for waterproofing of roof substrates but they can also be used for waterproofing of below ground structures, such as base slabs, walls, floors, basements, and tunnels. LAMs are also used for waterproofing of complex details, such as flashings, roof/wall penetrations, and joints.

LAMs can be provided as non-reactive or reactive one-component and multi-component compositions. Typical non-reactive compositions include water- and solvent-based solutions, which are applied on the substrate to form a wet layer, which is then cured by allowing the water/solvent contained in the wet film to evaporate. Commercially available reactive liquid applied compositions are based on use of polymers, such as polyurethanes, comprising moisture curing functional groups, such as isocyanate and silane groups. Further non-reactive compositions used in various waterproofing applications include one-component non-reactive hot-melt membranes that are applied on the surface as a melt and physically cured by cooling.

Prefabricated and liquid applied bitumen membranes are widely used in waterproofing of roofs, terraces, tanks, podiums, and below-grade structures, since they provide good resistance against environmental factors combined with relatively low costs compared to thermoplastic polymer materials and rubbers. Prefabricated bitumen membranes are provided as “torch-on” (torch-applied) and as peel and stick versions. Torch-on bitumen membranes are rolled out onto the substrate, and a construction worker uses a hand-held propane torch to heat the material and adhere it to the surface of the substrate. Peel and stick bitumen membranes comprise a self-adhering bituminous layer and they are generally easier to install than the torch-on membranes.

Hot-melt bitumen membrane compositions can also be used for waterproofing of roof decks, plaza decks, bridge decks, parking decks, reflecting pools, shower sub-floors, kitchen sub-floors, mechanical room sub-floors, foundation walls, mud slabs, tunnels, planters, vegetated (green) roofs, and blue roofs. In some installations, such as waterproofing of roof flashings, penetrations, expansion joints, or other substrates with a transition area, a reinforcing layer, such as a polyester fabric or uncured neoprene sheet, is used to improve the mechanical strength of the cured membrane. In these applications, the reinforcing sheet is encapsulated between two layers of the hot-melt bitumen membrane composition.

The general disadvantage of using such reinforcing sheets is that they have been found out to provide a relatively low bonding to the hot-melt bitumen membrane layers. Another disadvantage is that neoprene has been included in the Red List of the Living Building Challenge (LBC). The Red List of materials, which was originally created by Healthy Building Network in 2006 and revised by International Living Future Institute (ILFI), represents the “worst in class” materials, chemicals, and elements known to pose serious risks to human health and the greater ecosystem that are prevalent in the building products industry.

There thus remains a need for an improved method for waterproofing below and above ground structures using bitumen-based materials without the use of materials that are included in the Red List of the Living Building Challenge (LBC).

### SUMMARY OF THE INVENTION

The object of the present invention is to provide a method for waterproofing a substrate that overcomes or at least mitigates the disadvantages of the prior art methods as discussed above.

Surprisingly it has been found out that the objects can be achieved with the features of claim 1.

Specifically, according to the invention, a method for waterproofing a substrate is proposed, the method comprising steps of:
I) Heating a hot melt bitumen membrane composition to provide a molten bitumen composition,
II) Applying a layer of the molten bitumen composition to a surface of the substrate (1) to form a first bitumen layer (2),
III) Covering at least a portion of an upper surface of the first bitumen layer (2) with a prefabricated reinforcement membrane (3), and
IV) Applying a layer of the molten bitumen composition to an upper surface of the prefabricated reinforcement membrane (3) to form a second bitumen layer (2′),

wherein the prefabricated reinforcement membrane (3) comprises a polymer-modified bitumen layer (4) comprising:
a) Bitumen B1 and
b) At least one first modifying polymer MP1.

As it turned out, the prefabricated reinforcement membrane comprising a polymer-modified bitumen layer shows an excellent bonding to the melt applied bitumen membrane layers enabling efficient waterproofing of roof substrates including a transition area, such as a roof drain, penetration, or an expansion joint. Furthermore, the use of the bitumen-based reinforcement membrane instead of the uncured neoprene membrane enables providing a waterproofed structure without using any materials that are included Red List of the Living Building Challenge (LBC).

Additional aspects of the present invention are presented in further independent claims. Preferred embodiments of the invention are outlined throughout the description and the dependent claims.

### BRIEF DESCRIPTION OF THE DRAWINGS

FIG. 1 shows a cross-section of a prefabricated reinforcement membrane (3) comprising a polymer-modified bitumen layer (4), a further polymer-modified bitumen layer (4′), and a reinforcing layer (5) arranged between these.

FIG. 2 shows a cross-section of a prefabricated reinforcement membrane (3) further comprising a surface finish layer (6) that forms the lower outermost layer of the prefabricated reinforcement membrane (3).

FIG. 3 shows a cross-section of a prefabricated reinforcement membrane (3) further comprising a surface finish layer (6) that forms the lower outermost layer of the prefabricated reinforcement membrane (3) and a further surface finish layer (6′) that forms the upper outermost layer of the prefabricated reinforcement membrane (3).

FIG. 4 shows a perspective view of a waterproofed substrate comprising first and second bitumen layers (2, 2′), a prefabricated reinforcement membrane (3) sandwiched between the bitumen layers (2, 2′) and a substrate (1).

### DETAILED DESCRIPTION OF THE INVENTION

The subject of the present invention is a method for waterproofing a substrate (1) comprising steps of:
I) Heating a hot melt bitumen membrane composition to provide a molten bitumen composition,
II) Applying a layer of the molten bitumen composition to a surface of the substrate (1) to form a first bitumen layer (2),
III) Covering at least a portion of an upper surface of the first bitumen layer (2) with a prefabricated reinforcement membrane (3), and
IV) Applying a layer of the molten bitumen composition to an upper surface of the prefabricated reinforcement membrane (3) to form a second bitumen layer (2′),

wherein the prefabricated reinforcement membrane (3) comprises a polymer-modified bitumen layer (4) comprising:
a) Bitumen B1 and
b) At least one first modifying polymer MP1.

The term “polymer” designates a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “molecular weight” refers to the molar mass (g/mol) of a molecule or a part of a molecule, also referred to as “moiety”. The term “average molecular weight” refers to number average molecular weight (Mn) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “melting temperature” refers to a temperature at which a material undergoes transition from the solid to the liquid state. The melting temperature (Tₘ) is preferably determined by differential scanning calorimetry (DSC) according to ISO 11357-3:2018 standard using a heating rate of 2° C./min. The measurements can be performed with a Mettler Toledo DSC 3+device and the Tₘ values can be determined from the measured DSC-curve with the help of the DSC-software. In case the measured DSC-curve shows several peak temperatures, the first peak temperature coming from the lower temperature side in the thermogram is taken as the melting temperature I.

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one modifying polymer MP” refers to the sum of the individual amounts of all modifying polymers MP contained in the composition. Furthermore, in case the composition comprises 20 wt.-% of the at least one modifying polymer MP, the sum of the amounts of all modifying polymers MP contained in the composition equals 20 wt.-%.

The term “room temperature” designates a temperature of 23° C.

Step III) of the method comprises covering at least a portion of an upper surface of the first bitumen layer with a prefabricated reinforcement membrane. In a preferred embodiment, only a portion of the upper surface of the first bitumen layer is covered with the prefabricated reinforcement membrane.

The term “prefabricated membrane” refers in the present disclosure to sheet-like articles, which have been formed before being applied on a surface of a substrate to be waterproofed. Generally, prefabricated membranes have not been formed in situ, i.e. not been formed on the surface of the substrate to be waterproofed during application. They are typically produced at a location that is remote from the installation site, brought to the site, for example, in the form of a roll, and laid on a surface of a substrate.

The prefabricated reinforcement membrane applied over the first bitumen layer comprises a polymer-modified bitumen layer comprising:
a) Bitumen B1 and
b) At least one first modifying polymer MP1.

The term “bitumen” refers in the present disclosure to blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B1 present in the polymer-modified bitumen layer can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically have low penetration values and high softening-points.

Preferably, the bitumen B1 comprises at least 65 wt.-%, more preferably at least 75 wt.-%, even more preferably at least 85 wt.-% of at least one penetration grade bitumen, preferably having a penetration value in the range of 30-300 dmm, more preferably 70-220 dmm, even more preferably 100-160 dmm and/or a softening point determined by Ring and Ball measurement conducted according to EN 1427:2015 standard in the range of 30-100° C., more preferably 30-70° C., even more preferably 30-50° C.

The polymer-modified bitumen layer comprises, in addition to the bitumen B1, at least one first modifying polymer MP1.

Suitable polymers for use as the modifying polymer MP1 include, for example, polyolefins, particularly atactic polypropylene (APP) and amorphous poly-α-olefins (APAO), styrene block copolymers, and rubbers.

The term “amorphous poly-α-olefins (APAO)” refers in the present disclosure to polyolefins to having a low crystallinity degree determined by a differential scanning calorimetry (DSC) measurements, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. Particularly, the term “amorphous poly-α-olefins olefin” designates poly-α-olefins lacking a crystalline melting pol(Tm) as determined by differential scanning calorimetric (DSC) or equivalent technique.

Particularly suitable amorphous poly-α-olefins for use as the first modifying polymer MP1 include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the modifying polymer MP1 include, particularly styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (polyethylene-propylene), or completely or partially hydrogenated polybutadiene (polyethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the modifying polymer MP1 include at least styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

The term “rubber” refers to any polymer or combination of polymers, which is capable of recovering from large deformations. Typical elastomers are capable of being elongated or deformed to at least 200% of their original dimension under an externally applied force, and will substantially resume the original dimensions, sustaining only small permanent set (typically no more than about 20%), after the external force is released. As used herein, the term “elastomer” may be used interchangeably with the term “rubber.” Particularly, the term “rubber” refers to elastomers that are not chemically crosslinked. The term “chemically crosslinked” is understood to mean that the polymer chains forming the elastomer are inter-connected by a plurality of covalent bonds, which are stable mechanically and thermally.

Suitable rubbers for use as the modifying polymer MP1 include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

In one or more embodiments, the at least one modifying polymer MP1 is selected from atactic polypropylene (APP), amorphous poly-α-olefins (APAO), styrene-butadiene-styrene

(SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from atactic polypropylene (APP), amorphous poly-α-olefins (APAO), styrene-butadiene-styrene (SBS) block copolymer, styrene-isoprene-styrene (SIS) block copolymer, and styrene-butadiene rubber (SBR).

In one or more embodiments, the polymer-modified bitumen layer comprises:
a) 25-90 wt.-%, preferably 30-85 wt.-%, more preferably 35-80 wt.-%, of bitumen B1 and
b) 5-45 wt.-%, preferably 10-40 wt.-%, more preferably 10-35 wt.-%, of the at least one first modifying polymer MP1, and
c) 0-60 wt.-%, preferably 1.5-35 wt.-%, more preferably 2.5-25 wt.-%, of at least one first inorganic filler F1, all proportions being based on the total weight of the polymer-modified bitumen layer.

Particularly suitable compounds to be used as the inorganic filler F1 include, for example, sand, granite, calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present disclosure to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as inert mineral filler refers in the present document to calcitic fillers produced from chalk, limestone, or marble by grinding and/or precipitation.

In one or more embodiments, the at least one inorganic filler F1 is selected from the group consisting of calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, and fused silica.

Preferably, the at least one inorganic filler F1 has a median particle size d₅₀ of not more than 150 μm, more preferably not more than 100 μm. According to one or more embodiments, the at least one inorganic filler F1 has a median particle size d₅₀ of 0.1-100 μm, preferably 0.15-50 μm, more preferably 0.15-25 μm, even more preferably 0.25-15 μm.

The term “particle size” refers in the present disclosure to the area-equivalent spherical diameter of a particle (Xarea). The term “median particle size d₅₀” refers to a particle size below which 50% of all particles by volume are smaller than the d₅₀ value. In analogy, the term doo particle size refers in the present disclosure to a particle size below which 90% of all particles by volume are smaller than the d90 value and term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and for example, a Mastersizer 2000 device (trademark of Malvern Instruments Ltd, GB).

Preferably, the polymer-modified bitumen layer has a thickness of 0.1-2.5 mm, more preferably 0.1-1.5 mm, even more preferably 0.25-1.25 mm, still more preferably 0.35-1 mm.

The hot melt bitumen membrane composition, which is applied as a melt on steps II) and IV) of the method, preferably comprises:
A) 25-65 wt.-%, preferably 35-55 wt.-% of bitumen B2,
B) 0.5-15 wt.-%, preferably 1.5-10 wt.-% of at least one second modifying polymer MP2, and
C) 5-50 wt.-%, preferably 15-40 wt.-% of at least one second inorganic filler F2, and
D) 0-15 wt.-%, preferably 0.5-10 wt.-% of at least one plasticizer PL, all proportions being based on the total weight of the hot melt bitumen membrane composition.

The preferences given above for the bitumen B1, the first modifying polymer MP1, and the first inorganic filler F1 are equally applicable to the bitumen B2, the second modifying polymer MP2, and to the second inorganic filler F2.

The at least one plasticizer PL is preferably selected from mineral oils, synthetic oils, vegetable oils, and at 25° C. liquid hydrocarbon resins.

The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-Ill base oils according to the classification of the American Petroleum Institute (API).

Suitable mineral oils to be used as the plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

T″e term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

Suitable at 25° C. liquid hydrocarbon resins for use as the plasticizer PL include at 25° C. liquid polybutenes and at 25° C. liquid polyisobutylenes (PIB). The term “at 25° C. liquid polybutene” designates in the present disclosure low molecular weight olefin oligomers comprising isobutylene and/or 1-butene and/or 2-butene. The ratio of the C₄-olefin isomers can vary by manufacturer and by grade. When the C₄-olefin is exclusively 1-butene, the material is referred to as “poly-”-butene” or “PNB”. The term “at 25° C. liquid polyisobutylene” designates in the present disclosure low molecular weight polyolefins and olefin oligomers of isobutylene, preferably containing at least 75%, more preferably at least 85% of repeat units derived from isobutylene. Particularly suitable at 25° C. liquid polybutenes and polyisobutylenes have a molecular weight (Mn) of not more than 10000 g/mol, preferably not more than 5000 g/mol, more preferably not more than 3500 g/mol, even more preferably not more than 3000 g/mol, still more preferably not more than 2500 g/mol.

Liquid polybutenes are commercially available, for example, under the trade name of Indopol® H- and L-series (from Ineos Oligomers), under the trade name of Infineum® C-series and Parapol® series (from Infineum), and under the trade name of PB-series (Daelim). Liquid polyisobutylenes (PIBs) are commercially available, for example, under the trade name of Glissopal® V-series (from BASF) and under the trade name of Dynapak®-series (from Univar GmbH, Germany).

The first step I) of the method comprises heating the hot melt bitumen membrane composition to provide a molten bitumen composition, which then applied to form the first and second bitumen layers.

Depending on the type of bitumen and on the proportion of the other constituents, it may be preferred that the hot melt bitumen membrane composition is heated in step) to a temperature of at least 145° C., preferably at least 165° C., more preferably at least 175° C., to provide the molten bitumen composition. The melting of the hot melt bitumen membrane composition can be conducted using conventional techniques, such as a double shell melter.

The molten bitumen compositions can then be applied in steps II) and IV) of the method by using any conventional techniques, such as by using a roller, brush, or a squeegee. Typically, the molten bitumen composition is first poured from a container to one or more locations on the surface of the substrate to be waterproofed and then then spread over the surface to form a continuous monolithic layer.

Preferably, the prefabricated reinforcement membrane further comprises a reinforcing layer, preferably selected from a polymeric layer, a layer of fiber material, and a metallic film.

The term “polymeric layer” or “polymer layer” refers in the present disclosure to a layer comprising a continuous phase composed of one or more polymers whereas the term “particle-based layer” refers to a layer composed of solid particles.

Suitable polymeric layers for use as the reinforcing layer in the prefabricated reinforcement membrane include singly-layer and multi-layer polymeric foils, particularly comprising at least one polymer selected from polyethylene, cross-laminated high-density polyethylene, polypropylene, chlorosulfonated polyethylene, ethylene propylene diene rubber, polyisobutylene, ethylene vinyl acetate copolymer, polyvinylchloride, polyethylene terephthalate, polystyrene, polyamide, ethylene vinyl alcohol, polyvinylidene chloride, and polyvinyl alcohol.

In one or more embodiments, the polymeric layer comprises at least one layer comprising at least one polymer selected from polyethylene, cross-laminated high-density polyethylene, polypropylene, chlorosulfonated polyethylene, ethylene vinyl acetate copolymer, polyvinylchloride, polyethylene terephthalate, polystyrene, polyamide, ethylene vinyl alcohol, polyvinylidene chloride, and polyvinyl alcohol.

Suitable layers of fiber material for use as the reinforcing layer in the prefabricated reinforcement membrane include non-woven fabrics and laid scrims, preferably having as the main fiber component synthetic organic and/or inorganic fibers.

The term “non-woven fabric” designates in the present disclosure materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric.

Preferred synthetic organic fibers include polyester fibers, polypropylene fibers, polyethylene fibers, nylon fibers, and polyamide fibers whereas glass fibers, aramid fibers, wollastonite fibers, and carbon fibers are preferred inorganic fibers for the non-woven fabrics.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim. Typical materials for laid scrims include metal fibers, inorganic fibers, in particular glass fibers, and synthetic organic fibers, particularly polyester, polypropylene, polyethylene, and polyethylene terephthalate (PET).

Especially suitable layers of fiber material include non-woven fabrics comprising synthetic organic and/or inorganic fibers and having a mass per unit weight of not more than 500 g/m², preferably not more than 350 g/m², particularly 15-350 g/m², preferably 25-300 g/m², more preferably 35-250 g/m², even more preferably 50-200 g/m².

In one or more embodiments, the layer fiber material is a non-woven fabric, preferably having as the main fiber component synthetic organic fibers or inorganic fibers, preferably synthetic organic fibers, preferably selected from polyester fibers, polypropylene fibers, polyethylene fibers, nylon fibers, and polyamide fibers.

Especially suitable metal films for use as the reinforcing layer in the prefabricated reinforcement membrane include aluminum films. Composite films comprising one or more metal films and one or more polymer films are also suitable.

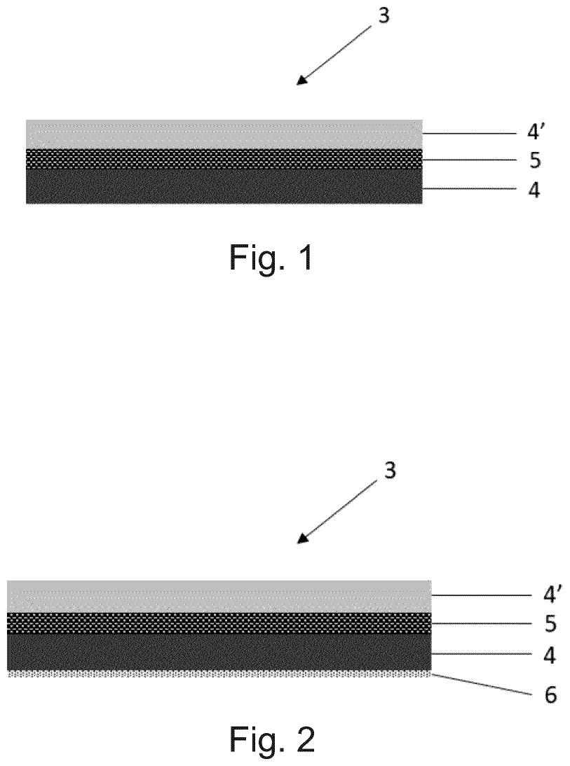

Preferably, the prefabricated reinforcement membrane comprises a further polymer-modified bitumen layer (4′), wherein the reinforcing layer (5) is arranged between the polymer-modified bitumen layer (4) and the further polymer-modified bitumen layer (4′), as shown in FIG. 1.

The further polymer-modified bitumen layer preferably comprises bitumen and at least one modifying polymer.

In one or more embodiments, the further polymer-modified bitumen layer comprises:
a) 25-90 wt.-%, preferably 30-85 wt.-%, more preferably 35-80 wt.-%, of bitumen B1′ and
b) 5-45 wt.-%, preferably 10-40 wt.-%, more preferably 10-35 wt.-%, of at least one first modifying polymer MP1′, and
c) 0-60 wt.-%, preferably 1.5-35 wt.-%, more preferably 2.5-25 wt.-%, of at least one first inorganic filler F1′, all proportions being based on the total weight of the further polymer-modified bitumen layer.

The preferences given above for the bitumen B1, the first modifying polymer MP1, and to the first inorganic filler F1, are equally applicable to the bitumen B1′, the first modifying polymer MP1′, and to the first inorganic filler F1′.

It may be further be preferred that the first modifying polymer MP1′ and its proportion in the further polymer-modified bitumen layer (4′) is identical to the first modifying polymer MP1 and its proportion in the polymer-modified bitumen layer (4). In one or more preferred embodiments, the polymer-modified bitumen and the further the polymer-modified bitumen have substantially identical compositions.

Preferably, the further polymer-modified bitumen layer has a thickness of 0.1-2.5 mm, more preferably 0.1-1.5 mm, even more preferably 0.25-1.25 mm, still more preferably 0.35-1 mm.

In one or more embodiments, the prefabricated reinforcement membrane further comprises a surface finish layer that forms one of the outermost layers of the prefabricated reinforcement membrane, wherein the surface finish layer is selected from a polymer layer, a particle-based layer, and a metal film.

FIG. 2 shows a cross-section of a prefabricated reinforcement membrane (3) used in the method for waterproofing a substrate according to one embodiment of the present invention. In this embodiment, the membrane (3) comprises, in addition to the layers shown in FIG. 1, a surface finish layer (6) that covers the lower surface of the polymer-modified bitumen layer (4) and forms the lower outermost layer of the membrane (3).

Generally, the preferences given above for the composition and buildup of the polymeric layer and the metallic film, which can be used as the reinforcement layer, apply equally for the polymer layer and the metal film, which can be used as the surface finish layer, unless otherwise stated.

In one or more embodiments, the polymer layer for use as the surface finish layer has a thickness of not more than 50 μm, preferably not more than 35 μm, particularly 2.5-25 μm, especially 5-20 μm.

Suitable particle-based layers for use as the surface finish layer in the prefabricated reinforcement membrane include, for example, layers of inert mineral particles.

In one or more embodiments, the particle-based layer of the surface finish layer comprises or is composed of inorganic mineral particles, preferably selected from sand, talcum, gravel, and slates.

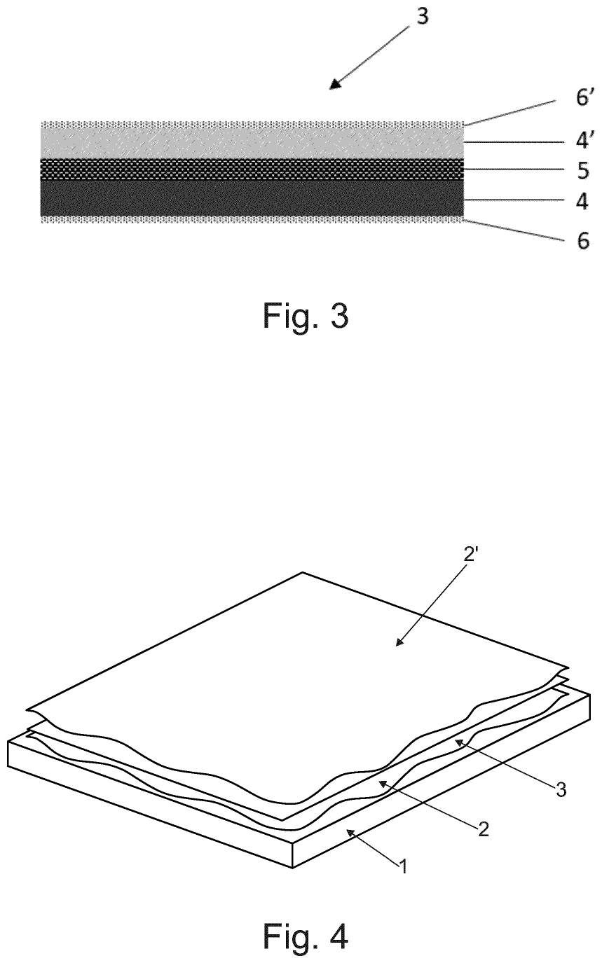

FIG. 3 shows a cross-section of a prefabricated reinforcement membrane (3) used in the method for waterproofing a substrate according to one embodiment of the present invention. In this embodiment, the membrane (3) comprises, in addition to the layers shown in FIG. 2, a further surface finish layer (6′) that covers the upper surface of the further polymer-modified bitumen layer (4′) and forms the upper outermost layer of the membrane (3).

Generally, the outermost layers or the prefabricated reinforcement membrane preferably have a non-tacky primary exterior surface. The term “primary exterior surface of an outermost layer” refers to the surface of the outermost layer facing away from the interior of the membrane.

In one or more embodiments, the primary exterior surfaces of the outermost layers or the prefabricated reinforcement membrane exhibit a loop tack adhesion to a glass plate measured at a temperature of 23° C. of not more than 0.5 N/25 mm, preferably not more than 0.25 N/25 mm, more preferably not more than 0.1 N/25 mm, wherein the loop tack adhesion is measured “sing a “FINAT test method no. 9 (FTM 9) as defined in FINAT Technical Handbook, 9th edition, published in 2014.

The prefabricated reinforcement membrane preferably exhibits, in addition to good bonding to hot melt bitumen membrane compositions, sufficient mechanical properties, particularly elongation at break and maximum tensile strength, which enable its use in various waterproofing applications, especially in waterproofing of roof substrates.

In one or more embodiments, the prefabricated reinforcement membrane has:
an elongation at break measured according to EN 12311-1 standard of at least 100%, preferably at least 125%, more preferably at least 150% and/or
a maximum tensile strength measured according to EN 12311-1 standard of at least 100 N/50 mm, preferably at least 125 N/50 mm, more preferably at least 150 N/50 mm.

In one or more embodiments, the prefabricated reinforcement membrane has a thickness of 0.5-5 mm, preferably 0.75-3.5 mm, more preferably 1-3 mm, even more preferably 1.25-2.5 mm.

There are no particular limitations for the width and length of the prefabricated reinforcing membrane and preferred dimensions of the membrane depend on the type of the substrate to be waterproofed. For example, the prefabricated reinforcement membrane can have a width and/or length in the range of 0.25-2.5 m, preferably 0.35-2 m, more preferably 0.5-1.5 m.

The further details of the method for waterproofing a substrate depend mainly on the embodiment of the substrate, for example, on the surface materials and buildup of the substrate.

In one or more embodiments, the method for waterproofing a substrate comprises a further step of applying a layer of primer material to the surface of the substrate, wherein the step of applying the primer material is conducted before step II).

The primer material can be applied to the surface of the substrate by using any conventional techniques, such as by using a roller, brush, or a squeegee. For example, the primer material can first be poured from a container to one or more locations on the surface of the substrate to be waterproofed and then then spread over the surface to form a continuous monolithic layer.

In one or more embodiments, the method for waterproofing a substrate comprises a further step of covering at least a portion of an upper surface of the second bitumen layer with a protection sheet.

The protection sheet can be used to protect the waterproofed structure, particularly the second bitumen layer, from mechanical impacts, for example, caused by foot traffic, and to separate the second bitumen layer from the insulation board placed above it. Such protective sheets are especially suitable for use in waterproofing of exposed substrates, particularly roof substrates.

Suitable protective sheets include polymer- and bitumen-based membrane sheets, which can be provided as single or multi-layer buildups.

In one or more embodiments, the substrate to be waterproofed contains a transition area comprising a first surface composed of a first material and a second surface composed of a second material. The first and second materials can be composed of same or different materials.

In one or more embodiments, the transition area comprises a roof drain, roof deck drain, penetration for a pipe or conduit, curb, or a joint, particularly an expansion joint.

In one or more embodiments, the transition area comprises a roof drain or a roof deck drain comprising a penetration and a drain flange, preferably composed of plastic material, wherein the method for waterproofing a substrate comprises a further step of installing a clamping ring after conducting step III) and before conducting step IV).

The step of installing the clamping ring preferably comprises positioning the clamping ring to the surface of the applied reinforcement membrane and fastening it to the drain flange preferably using mechanical fastening means, such as screws.

When the transition area comprises a roof drain or a roof deck drain, the method for waterproofing a substrate preferably comprises a further step of cutting a hole to the reinforcement membrane in the area located inside the clamping ring.

In one or more further embodiments, the transition area comprises joint, particularly an expansion joint, wherein the first and second surfaces of the transition area are composed of concrete and the joint is located between the first and second surfaces.

Expansion joints are typically formed in concrete structures at regular intervals to accommodate the movement caused by expansion of concrete mass. Substrates comprising an expansion joint having an anticipated movement of not more than 25% of the original width and/or a width of not more than 50 mm are especially suitable to be waterproofed using the method of the present invention.

When the transition are comprises a joint, particularly an expansion joint, the method for waterproofing a substrate preferably comprises a further step of covering at least a portion of the second bitumen layer with a further layer reinforcement layer and applying a layer of the molten bitumen composition to an upper surface of the further prefabricated reinforcement membrane on both sides of the joint to form third and fourth bitumen layers.

In embodiments where the transition area comprises an expansion joint, it may be preferred that the third and fourth bitumen layers do not form one monolithic layer but that a portion of the upper surface of the further prefabricated reinforcement membrane is left free of the bitumen layer. Furthermore, in these embodiments the method may comprise a further step of installing a foam tube or rod into the expansion joint before the first bitumen layer is applied.

The preferences given above for the bitumen B1, the first modifying polymer MP1, the first inorganic filler F1, the bitumen B2, the second modifying polymer MP2, the second inorganic filler F2, the reinforcing layers, and to the surface finish layers apply equally to all other aspects of the present invention, unless stated otherwise.

Another aspect of the present invention is a waterproofed substrate obtained by using the method for waterproofing a substrate of the present invention. A waterproofed structure according to one embodiment is shown in FIG. 4 comprising a substrate (1), first and second bitumen layer (2, 2′), a prefabricated reinforcement membrane (3) located between the first and second bitumen layers (2, 2).

Yet another aspect of the present invention is a kit-of-parts comprising:
i. A hot melt bitumen membrane composition and
ii. A prefabricated reinforcement membrane (3),

wherein the prefabricated reinforcement membrane (3) comprises a polymer-modified bitumen layer (4) comprising:
a) Bitumen B1 and
b) At least one modifying polymer MP1.

In one or more embodiments, the polymer-modified bitumen layer comprises:
a) 25-90 wt.-%, preferably 30-85 wt.-%, more preferably 35-80 wt.-%, of bitumen B1 and
b) 5-45 wt.-%, preferably 10-40 wt.-%, more preferably 10-35 wt.-%, of the at least one first modifying polymer MP1, and
c) 0-60 wt.-%, preferably 1.5-35 wt.-%, more preferably 2.5-25 wt.-%, of at least one first inorganic filler F1, all proportions being based on the total weight of the polymer-modified bitumen layer.

In one or more embodiments, the hot melt bitumen membrane composition comprises:
A) 25-65 wt.-%, preferably 35-55 wt.-% of bitumen B2,
B) 0.5-15 wt.-%, preferably 1.5-10 wt.-% of at least one second modifying polymer MP2, and
C) 5-50 wt.-%, preferably 15-40 wt.-% of at least one second inorganic filler F2, all proportions being based on the total weight of the hot melt bitumen membrane composition.

Preferably, the prefabricated reinforcement membrane further comprises a reinforcing layer, preferably selected from a polymeric layer, a layer of fiber material, and a metallic film. Preferred embodiments of the reinforcing layer have already been discussed above.

Preferably, the prefabricated reinforcement membrane comprises a further polymer-modified bitumen layer, wherein the reinforcing layer is arranged between the polymer-modified bitumen layer and the further polymer-modified bitumen layer.

Preferred embodiments of the further polymer-modified bitumen layer have already been discussed above.

In one or more embodiments, the prefabricated reinforcement membrane further comprises a surface finish layer that forms one of the outermost layers of the prefabricated reinforcement membrane, wherein the surface finish layer is selected from a polymer layer, a particle-based layer, and a metal film.

Preferred embodiments of the surface finish layer have already been discussed above.

In one or more embodiments, the prefabricated reinforcement membrane has an elongation at break measured according to EN 12311-1:2010 standard of at least 100%, preferably at least 125%.

The hot melt bitumen membrane composition may be provided in the kit-of-parts as a packaged composition comprising a piece of the hot melt bitumen membrane composition wrapped in a polymer film, for example, a polyethylene film. During use, the packaged composition can be melted without removing the polymer film using conventional techniques, such as a double shell melter.

Still another aspect of the present invention is use of the kit-of-parts of the present invention for providing a waterproofed substrate, preferably a waterproofed roofing substrate.

In one or more embodiments, the substrate comprises at least one of a roof drain, roof deck drain, a penetration for a pipe or conduit, curb, or a joint, particularly an expansion joint.

The use of the kit-of-parts for providing a waterproofed substrate preferably comprises steps of:
Providing the kit-of-parts,
Heating the hot melt bitumen membrane composition to provide a molten bitumen composition,
Applying a layer of the molten bitumen composition to a surface of the substrate to form a first bitumen layer,
Covering at least a portion of an upper surface of the first bitumen layer with a prefabricated reinforcement membrane, and
Applying a layer of the molten bitumen composition to an upper surface of the prefabricated reinforcement membrane to form a second bitumen layer.

It goes without saying that any removable release liners covering a surface of the prefabricated reinforcement membrane are removed before the corresponding surfaces are contacted with molten bitumen composition.

In a preferred embodiment, only a portion of the upper surface of the first bitumen layer is covered with the prefabricated reinforcement membrane.

### Examples

### Used Materials

A neoprene membrane having a thickness of ca. 1.5 mm was used as the prefabricated reinforcement membrane in reference examples Ref-1 (uncured) and Ref-2 (cured). The neoprene membrane is commercially available under the trade name of Flex-Flesh® UN (from Sika Corporation).

The buildup of the tested prefabricated reinforcement membranes and results of the measurements are shown in Table 1.

The membranes were adhered to concrete substrate using a hot-melt bitumen membrane composition, which is commercially available under the trade name of MM6125 (from Sika Corporation).

### Tensile Strength and Elongation at Break

The elongation and tensile strength at break of all the tested prefabricated reinforcement membranes were measured according to the EN 12311-1 standard.

In the testing for mechanical properties, samples of the membranes having dimensions of 25.4 mm×152.4 mm (width, length) were used. The clamp separation was 101.6 mm and the beam speed was of 50.8 mm/min.

### Peel Adhesion at Angle of 90°

The compatibility between the tested reinforcement membranes and the hot-melt bitumen membrane composition was investigated by measuring average peel resistances obtained upon peeling a sample of the prefabricated reinforcement membrane from a surface of a concrete substrate to which the sample had been adhered using the hot-melt bitumen membrane composition.

The test specimens used in peel strength measurements were prepared according to the following procedure. Rectangular samples having dimensions of 6×9 inch were first cut from the tested membranes. The samples were then bonded on a surface of rectangular concrete substrates having dimensions of 6×6×0.5 inch (width×length×thickness) using the hot-melt bitumen membrane composition.

The hot-melt bitumen membrane composition was heated in a melter to a temperature of 175-190° C. and mixed at this temperature for 5-10 minutes. The molten bitumen composition was applied to the surface of the concrete substrate to form a layer having a thickness of ca. 3 mm. Once the temperature of the bitumen layer reached ca. 150° C., the layer was covered with the tested reinforcement membrane. In case the tested membrane contained a surface finish layer, the membrane was applied to the concrete substrate such that the surface finish layer was directly contacted with the bitumen layer. The thus obtained test specimens were stored for 15 days at normal room temperature before measuring of the peel resistances.

The peel resistances were measured using the method in accordance with in EN 1372 standard and using a Zwick tensile testing apparatus equipped with a 90°-peeling element. In the peel resistance measurements, the adhered sample of the reinforcement membrane was peeled off at a peeling angle of 90° and a constant cross beam speed of 100 mm/min. The average peel resistance was calculated as average peel force per unit width of the strip [N/50 mm] during peeling over a length of approximately 120 mm excluding the first and last 10 mm of the total peeling length from the calculation. The average peel resistance values shown in Table 1 were calculated as an average of measured values obtained with five test specimens.

TABLE 1

| | ^{a}Ref-1 | ^{b}Ref-2 | Ex-1 | Ex-2 | Ex-3 | Ex-4 |
|---|---|---|---|---|---|---|
| Bitumen membrane type | | | A | B | C | D |
| Surface finish layer | — | — | — | — | PE film | — |
| Polymer-modified bitumen layer (MP1) | — | — | SBS | SBS | SBS | SBS |
| Reinforcement layer | — | — | Polyester | CL HDPE | Polyester | PP film |
| Further polymer-modified bitumen layer (MP1′) | — | — | SBS | SBS | SBS | SBS |
| Further surface finish layer | — | — | — | — | PE film | — |
| Measured properties | | | | | | |
| Elongation at Fmax (MD) [%] | 241 | 188 | 41 | 375 | 41 | 416 |
| Elongation at Fmax (CD) [%] | 287 | 228 | 65 | 361 | 65 | 413 |
| Fmax (MD) [N/50 mm] | 289 | 412 | 333 | 263 | 333 | 158 |
| Fmax (CD) [N/50 mm] | 245 | 377 | 280 | 263 | 280 | 193 |
| 90° peel resistance from concrete [N/50 mm] | 22 | — | 87 | 116 | 110 | 86 |

^{a}Flex-Flesh UN (uncured)
^{b}Flex-Flesh UN (cured)

1. A method for waterproofing a substrate comprising steps of:
I) heating a hot melt bitumen membrane composition to provide a molten bitumen composition,
II) applying a layer of the molten bitumen composition to a surface of the substrate to form a first bitumen, layer,
III) covering at least a portion of an upper surface of the first bitumen layer with a prefabricated reinforcement, membrane, and
IV) applying a layer of the molten bitumen composition to an upper surface of the prefabricated reinforcement membrane to form a second bitumen, layer,
wherein the prefabricated reinforcement membrane comprises a polymer-modified bitumen layer comprising:
a) bitumen B1 and
b) at least one first modifying polymer MP1.

2. The method according to claim 1, wherein the prefabricated reinforcement membrane has an elongation at break measured according to EN 12311-1:2010 standard of at least 100%.

3. The method according to claim 1, wherein the polymer-modified bitumen layer comprises:
a) 25-90 wt.-%, of bitumen B1 and
b) 5-45 wt.-%, of the at least one first modifying polymer MP1, and
c) 0-60 wt.-%, of at least one first inorganic filler F1, all proportions being based on the total weight of the polymer-modified bitumen layer.

4. The method according to claim 1, wherein the polymer-modified bitumen layer has a thickness of 0.1-1.5 mm.

5. The method according to claim 1, wherein the hot melt bitumen membrane composition comprises:
A) 25-65 wt.-% of bitumen B2,
B) 0.5-15 wt.-% of a second modifying polymer MP2, and
C) 5-50 wt.-% of at least one second inorganic filler F2, all proportions being based on the total weight of the hot melt bitumen membrane composition.

6. The method according to claim 1, wherein steps II) and IV) of applying the molten bitumen composition are conducted using a roller, brush, or a squeegee.

7. The method according to claim 1, wherein the hot melt bitumen membrane composition is heated to a temperature of at least 145° C. to provide the molten bitumen composition.

8. The method according to claim 1, wherein the first and second bitumen layers have a coating weight of at least 1000 g/m².

9. The method according to claim 1, wherein the prefabricated reinforcement membrane further comprises a reinforcing layer.

10. The method according to claim 9, wherein the polymeric layer of the reinforcing layer comprises at least one layer comprising at least one polymer selected from polyethylene, cross-laminated high-density polyethylene, polypropylene, chlorosulfonated polyethylene, ethylene vinyl acetate copolymer, polyvinylchloride, polyethylene terephthalate, polyamide, ethylene vinyl alcohol, polyvinylidene chloride, and polyvinyl alcohol.

11. The method according to claim 9, wherein the prefabricated reinforcement membrane comprises a further polymer-modified bitumen, layer, wherein the reinforcing layer is arranged between the polymer-modified bitumen layer and the further polymer-modified bitumen layer.

12. The method according to claim 1, wherein the prefabricated reinforcement membrane further comprises a surface finish layer that forms one of the outermost layers of the prefabricated reinforcement, membrane, wherein the surface finish layer is selected from a polymer layer, a particle-based layer, and a metal film.

13. The method according to claim 1, wherein the substrate to be waterproofed includes a transition area comprising a first surface composed of a first material and a second surface composed of a second material.

14. The method according to claim 13, wherein the transition area comprises a roof drain, roof deck drain, a penetration for a pipe or conduit, curb, or a joint.

15. A waterproofed substrate obtained by using the method as defined in claim 1.

16. Kit-of-parts comprising:
i. a hot melt bitumen membrane composition and
ii. a prefabricated reinforcement membrane,
wherein the prefabricated reinforcement membrane comprises a polymer-modified bitumen layer comprising:
a) bitumen B1 and
b) at least one first modifying polymer MP1.

17. The kit-of-parts according to claim 16, wherein the prefabricated reinforcement membrane has an elongation at break measured according to EN 12311-1:2010 standard of at least 100%.

18. The kit-of-parts according to claim 17, wherein the polymer modified bitumen layer comprises:
a) 25-90 wt.-%, of the bitumen B1 and
b) 5-45 wt.-%, of the at least one first modifying polymer MP1, and
c) 0-60 wt.-%, of at least one first inorganic filler F1, all proportions being based on the total weight of the polymer-modified bitumen layer.

19. The kit-of-parts according to claim 17, wherein hot melt bitumen membrane composition comprises:
A) 25-65 wt.-% of bitumen B2,
B) 0.5-15 wt.-% of a second modifying polymer MP2, and
C) 5-50 wt.-% of at least one second inorganic filler F2, all proportions being based on the total weight of the hot melt bitumen membrane composition.

20. The method comprising providing a waterproofed substrate from the kit-of-parts according to claim 17.
